(19) United States
(12) Patent Application Publication
(10) Pub. No.: US 2024/0414572 A1
(43) Pub. Date: Dec. 12, 2024

(54) USER EQUIPMENT, NETWORK NODE AND METHODS IN A WIRELESS COMMUNICATIONS NETWORK

(71) Applicant: Telefonaktiebolaget LM Ericsson (publ), Stockholm (SE)

(72) Inventors: Sakib BIN REDHWAN, Linköping (SE); Pradeepa RAMACHANDRA, Linköping (SE)

(73) Assignee: Telefonaktiebolaget LM Ericsson (publ), Stockholm (SE)

(21) Appl. No.: 18/697,450

(22) PCT Filed: Sep. 29, 2022
(86) PCT No.: PCT/SE2022/050866

§ 371 Date: Mar. 29, 2024

Related U.S. Application Data
(60) Provisional application No. 63/262,146, filed on Oct. 6, 2021.

(51) Int. Cl. H04W 24/08; H04W 24/10

(52) U.S. Cl. CPC H04W 24/08; H04W 24/10

(57) ABSTRACT

A method performed by a User Equipment (UE) for performing measurement logging related to logged Minimization of Drive Tests (MDT) measurements in a wireless communications network. The UE receives an MDT measurement configuration that relates to logging MDT measurements in one or more inter-frequency carriers and one or more cells. When operating in an idle mode of operation and in a camped normally state, the UE monitors the configured one or more inter-frequency carriers and one or more cells. Based on the monitoring, the UE logs one or more MDT measurements relating to the received configuration, and one or more MDT measurement indications related to one or more other cells that are stronger than the cells in the received configuration. The UE sends a measurement report that comprises one or more of the one or more logged MDT measurements, and the one or more logged MDT measurement indications.

### TECHNICAL FIELD

Embodiments herein relate to a User Equipment (UE), a network node and methods therein. In some aspects, they relate to performing measurement logging related to logged Minimization of Drive Tests (MDT) measurements in a wireless communications network.

### BACKGROUND

In a typical wireless communication network, wireless devices, also known as wireless communication devices, mobile stations, stations (STA) and/or User Equipments (UE) s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### Minimization of Drive Tests (MDT)

MDT was standardized for NR in Rel-16 to reduce the amount of drive tests performed manually. It is a UE assisted framework where network measurements are collected by both IDLE/INACTIVE and RRC Connected UE(s) in order to aid the network in gathering valuable information. It has been specified for both LTE and NR in TS 37.320.

### MDT Types Based on RRC States

In general, there are two types of MDT measurement logging, i.e., Logged MDT and Immediate MDT.

### Logged MDT

A UE in RRC_IDLE/RRC_INACTIVE state is configured to perform periodical and event triggered MDT logging after receiving the MDT configurations from the network. The UE shall report the Downlink (DL) pilot strength measurements, e.g., Reference Signal Received Power (RSRP) and/or Reference Signal Received Quality (RSRQ), together with time information, detailed location information if available, and WLAN, Bluetooth to the network. The UE reports the DL pilot strength measurements using the UE information framework when it is in RRC_CONNECTED state. The DL pilot strength measurement of Logged MDT is collected based on the existing measurements required for cell reselection purpose, without imposing UE to perform additional measurements.

The table below shows measurement logging for Logged MDT

| MDT mode | RRC states | Measurement quantities |
|---|---|---|
| Logged MDT | RRC_IDLE/ | RSRP and RSRQ of the |
| | RRC_INACTIVE | serving cell and available UE |
| | | measurements for intra- |
| | | frequency/inter- |
| | | frequency/inter-RAT, time |
| | | stamp and detailed location |
| | | information if available |

For Periodical Logged MDT, the UE receives the MDT configurations including logginginterval and loggingduration in the RRC message, i.e., LoggedMeasurementConfiguration, from the network. A timer, e.g., T330, is started at the UE upon receiving the configurations and set to loggingduration, e.g., 10 min-120 min. The UE shall perform periodical MDT logging with the interval set to logginginterval, e.g., 1.28 s-61.44 s, when the UE is in RRC_IDLE. An example of the MDT logging is shown in the FIG. 1.

For event triggered Logged MDT, the UE receives eventType and logginginterval from the network. The UE logs the measurement reports at every logginginterval if event configured in eventType is satisfied. According to current standards, the UE logs different measurement values and cell identities in logged MDT report if it is in “camped normally” state or “any cell selection” state. Details description can be found in TS 37.320.

### Inter-Frequency Cell Information Logging

As part of logged MDT configuration, UEs may be configured to log measurements related to specific cells on a specific frequency. This is optionally configured using interFreqTargetInfo IE configured under AreaConfiguration IE. In absence of this IE, the UE logs measurements related to cells present in frequencies broadcasted through cell-reselection SIBs. However, in presence of this configuration, the UE only logs information regarding the frequencies and cells configured here. Detailed information is available in TS 38.331.

### Camped Normally State

In TS 38.304, different categories of cells and state of a UE in those cells are defined. One category of cell is called suitable cell where UEs may camp in idle state, monitor paging channels, system information etc. broadcasted by the network, and move to RRC_Connected state if required. A UE camping on a suitable cell is defined as being in “camped normally state”.

The network may configure a UE to log measurements related to some certain cells in some certain frequencies in the logged MDT report.

### SUMMARY

An object of embodiments herein is to improve MDT measurements performed in a wireless communications network.

According to an aspect of embodiments herein, the object is achieved by a method performed by a User Equipment (UE) for performing measurement logging related to logged Minimization of Drive Tests (MDT) measurements in a wireless communications network.

The UE receives an MDT measurement configuration from a network node. The measurement configuration relates to logging MDT measurements in one or more inter-frequency carriers and one or more cells.

When operating in an idle mode of operation and in a camped normally state, the UE monitors the configured one or more inter-frequency carriers and one or more cells.

Based on the monitoring, the UE logs one or more of:
One or more MDT measurements relating to the received configuration, and
one or more MDT measurement indications related to one or more other cells that are stronger than the one more cells the in the received configuration, and

The UE sends a measurement report to the network node. The measurement report comprising one or more of:
The one or more logged MDT measurements, and
the one or more logged MDT measurement indications.

The measurement report enables the network node to any one or more out of:
Generating a coverage map, and
generating an optimized configuration related to logged MDT measurements.

According to another aspect of embodiments herein, the object is achieved by a method performed by a network node for assisting a UE in performing measurement logging related to logged MDT measurements in a wireless communications network.

The network node configures the UE with an MDT measurement configuration. The measurement configuration relates to logging MDT measurements in one or more inter-frequency carriers and one or more cells.

The network node receives a measurement report from the UE. The measurement report comprises one or more of:
One or more logged MDT measurements, and
one or more logged MDT measurement indications related to one or more other cells that are stronger than the one more cells in the configuration.

The measurement report enables the network node to any one or more out of:
Generating a coverage map, and
Generating an optimized configuration related to logged MDT measurements.

According to another aspect of embodiments herein, the object is achieved by the UE. The UE is configured to perform measurement logging related to logged MDT measurements in the wireless communications network. The UE is further configured to:

Receive an MDT measurement configuration from a network node, which measurement configuration is adapted to be related to logging MDT measurements in one or more inter-frequency carriers and one or more cells,
when operating in an idle mode of operation and in a camped normally state, monitor the configured one or more inter-frequency carriers and one or more cells,
based on the monitoring, log one or more of:
   One or more MDT measurements adapted to be related to the received configuration, and
   one or more MDT measurement indications adapted to be related to one or more other cells that are stronger than the one more cells in the received configuration, and
send a measurement report to the network node, the measurement report adapted to comprise one or more of:
   The one or more logged MDT measurements, and
   the one or more logged MDT measurement indications,
which measurement report is adapted to enable the network node to any one or more out of:
   Generate a coverage map, and
   generate an optimized configuration adapted to be related to logged MDT measurements.

According to another aspect of embodiments herein, the object is achieved by the network node. The network node is configured to assist the UE in performing measurement logging related to logged MDT measurements in the wireless communications network. The network node is further configured to:
Configure the UE with an MDT measurement configuration, which measurement configuration is adapted to be related to logging MDT measurements in one or more inter-frequency carriers and one or more cells,
receive a measurement report from the UE, the measurement report adapted to comprise one or more of:
   One or more logged MDT measurements, and
   one or more logged MDT measurement indications adapted to be related to one or more other cells that are stronger than the one more cells in the configuration,
which measurement report is adapted to enable the network node to any one or more out of:
   Generate a coverage map, and
   generate an optimized configuration related to logged MDT measurements.

Embodiments herein target to handle MDT measurement logging. The UE, when operating in an idle state, monitors one or more inter-frequency carriers and one or more cells, logs one or more MDT measurements and/or one or more MDT measurement indicators related to the configuration, and sends a measurement report to the network node.

Embodiments herein may bring the advantage of efficient mechanisms to enable a UE to log information regarding the strongest cell in a frequency in which for some cells it was configured to log measurements as part of a logged MDT report. This is achieved by the network node configuring the UE to perform MDT measurement logging in one or more inter-frequency carriers and one or more cells and receive a measurement report from the UE related to the MDT measurement logging performed by the UE. This leads to an improved measurement mechanism, which results in improved MDT measurements performed in the wireless communications network.

### BRIEF DESCRIPTION OF THE DRAWINGS

Examples of embodiments herein are described in more detail with reference to attached drawings in which:

FIG. 1 illustrates an example of MDT measurements according to prior art.

FIG. 2 is a schematic block diagram illustrating embodiments of a wireless communications network.

FIG. 3 is a flowchart depicting embodiments of a method in a UE.

FIG. 4 is a flowchart depicting embodiments of a method in a network node.

FIGS. 5 a and b are schematic block diagrams illustrating embodiments of a UE.

FIGS. 6 a and b are schematic block diagrams illustrating embodiments of a network node.

FIG. 7 schematically illustrates a telecommunication network connected via an intermediate network to a host computer.

FIG. 8 is a generalized block diagram of a host computer communicating via a base station with a user equipment over a partially wireless connection.

FIGS. 9 to 12 are flowcharts illustrating methods implemented in a communication system including a host computer, a base station and a user equipment.

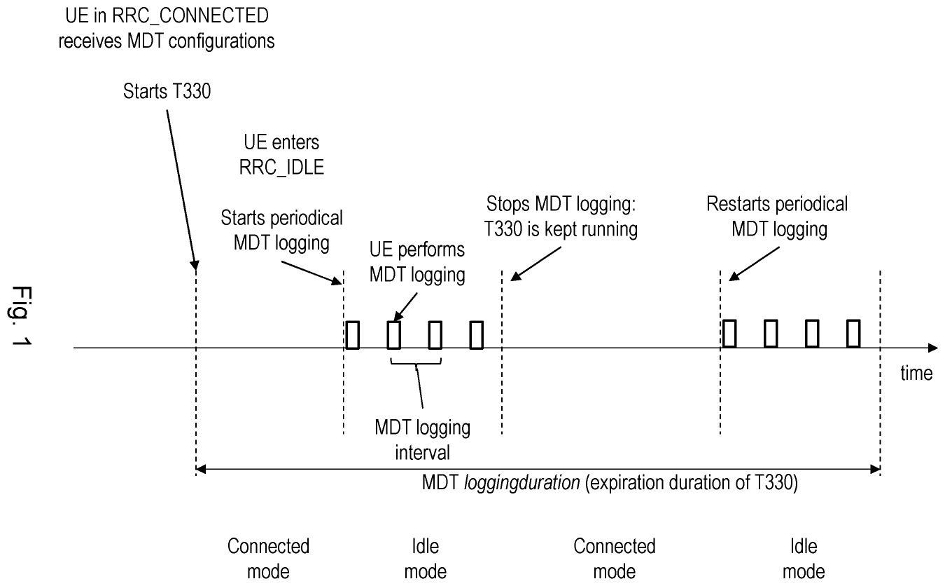

### DETAILED DESCRIPTION

As a part of developing embodiments herein the inventors identified a problem which first will be discussed.

In the current logged MDT framework, the network may configure a User Equipment (UE) to log measurements related to some certain cells in some certain frequencies in the logged MDT report. However, as part of a cell-reselection procedure, the UE may measure other cells outside of this configuration but not log information related to the cells that are not configured in logged MDT configuration. If the network is using the logged MDT framework to build a coverage map, it may interpret the results as the configured cells being the strongest cell in the location. However, the UE may have evaluated other cells as being the strongest cell in that location, but not logged it due to network configuration, e.g., the logged MDT configuration. Thus, the network is deprived of this information and may build an erroneous coverage map.

An object of embodiments herein is to improve MDT measurements performed in the wireless communications network.

Embodiments herein provide efficient mechanisms to enable a UE to log information regarding the strongest cell in a frequency in which for some cells it was configured to log measurements as part of a logged MDT report.

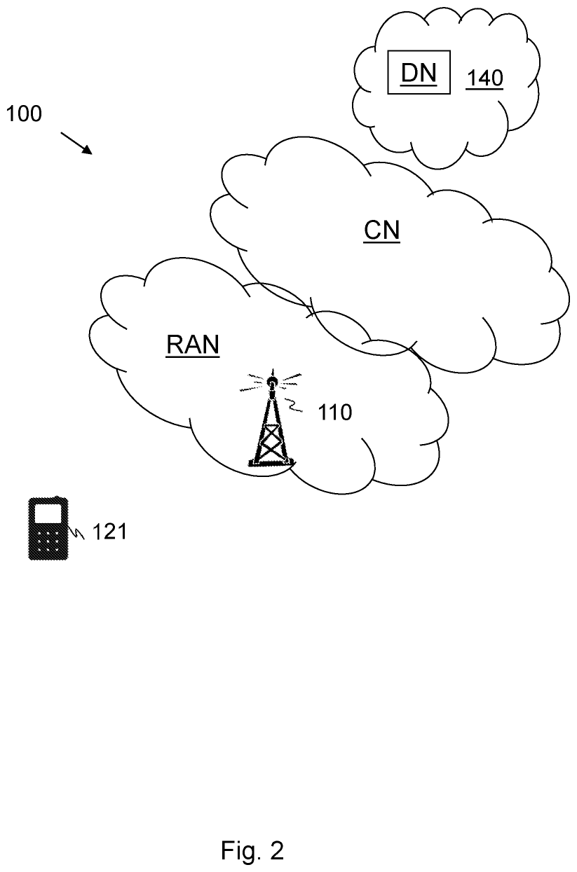

FIG. 2 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a network node 110 operate in the wireless communications network 100, by means of antenna beams, referred to as beams herein. The network node 110 e.g. provides a number of cells referred to as cell1 and cell2, and may use these cells for communicating with e.g. a UE 120. The RAN node 110 may be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within any of cell1 and cell2 served by the network node 110 depending e.g. on the radio access technology and terminology used.

User Equipments operate in the wireless communications network 100, such as a UE 121. The UE 121 may provide radio coverage by means of a number of antenna beams, also referred to as beams herein.

The UE 121 may e.g. be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Methods herein may in one aspect be performed by the network node 110, in another aspect by the UE 121. As an alternative, a Distributed Node (DN) and functionality, e.g. comprised in a cloud 140 as shown in FIG. 2, may be used for performing or partly performing the methods.

Embodiments herein provide a method performed by a wireless terminal, e.g., the UE 121, to log information indicating the strongest cell in a given frequency as part of logged MDT report. An example of the method performed by the UE 121 may comprise:
1) Receiving logged MDT configuration from the network node 110 where the configuration includes information regarding measurement logging in inter-frequency carriers and cells.
2) Transitioning to RRC_IDLE, camped normally state and monitoring the configured frequency and cells.
3) Logging measurements and indicator information related to the configured frequency and cells received in.

For example, the indicator information may be logged only when the configured cells are not the strongest cells in the corresponding frequency.

For example, the indicator information may be an implicit indication by not logging measurements of one or more of the configured cells if there is at least one better cell in the frequency than those cells whose measurements are omitted.

The indicator information may comprise one or more of the following:
A flag that there is at least one cell that is stronger than the cells logged in the report.
A Physical Cell Identity (PCI) of the strongest cell in the frequency.
The number of stronger cells than the configured cells in the frequency. This number may be calculated as the number of cells that are stronger than the strongest cell in the configured list of cells in the frequency.

Embodiments herein allow the network, such as the network node 110, to gather, such as obtain, receive and/or measure, information, e.g., by receiving a measurement report, related to strongest cell in a given location reported by the UE 121. Further, embodiments herein provide mechanisms for logging non-serving strongest cell information in a logged MDT report.

The network, such as the network node 110, may use this information to build robust coverage maps. Further, the network may use this information to create an optimized logged MDT configuration for a given UE, where the optimization is in sense of logging information related to minimum number of cells.

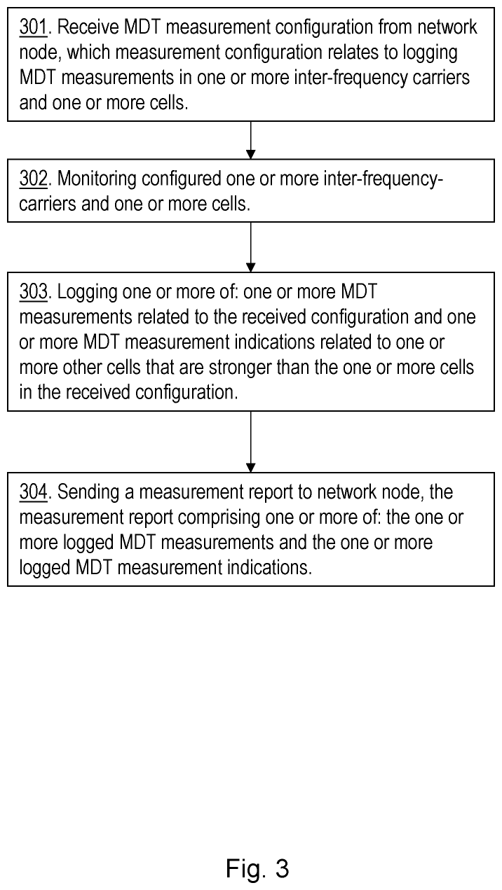

FIG. 3 shows an example method performed by the UE 121 e.g., for performing measurement logging related to logged MDT measurements in the wireless communications network 100. The method comprises any one or more out of the actions below, which actions may be taken in any suitable order:

### Action 301

The UE 121 receives an MDT measurement configuration from the network node 110. The measurement configuration relates to logging MDT measurements in one or more inter-frequency carriers and one or more cells. This may e.g., mean that the UE 121 applies the received configuration, resulting in that the UE 121 is configured with the received configuration.

The one or more cells may be one or more sets of cells. Each set of cells out of the one or more set of cells may comprise one or more cells.

Inter-frequency carriers when used herein, may mean carriers of different frequencies. The UE 121 may e.g., log MDT measurements according to each of the one or more inter-frequency carriers that the UE 121 not camped one when operating in an idle mode of operation. For example, the MDT measurement configuration comprises the inter-frequency carries f1, f2, f3 and f4 and the UE 121 is camped on f3. This means that the UE 121 may treat the frequency f3 as a serving frequency, and log e.g., MDT measurements and/or MDT measurement indications according to the received MDT measurement configuration for the frequencies, such as the inter-frequency carriers, f1, f2 and f4.

Each of the one or more inter-frequency carriers may be associated to one or more of the one or cells in the received configuration. In other words, the one or more inter-frequency carriers may be associated to a respective set of cells from the one or more cells. The respective sets of cells may comprise one or more cells, and the respective set of cells may be overlapping or disjoint sets of cells.

In some embodiments, the MDT measurement configuration configures the UE 121 to log one or more MDT measurement indications when the one or more cells in the received configuration is not the strongest cell in the corresponding frequency.

Receiving, when used herein, may e.g., mean receiving or in any other way obtaining the configuration from the network node 110. This definition is however not limited to this specific example but holds for any use of the word receiving herein.

### Action 302

When operating in an idle mode of operation and in a camped normally state, the UE 121 monitors the configured one or more inter-frequency carriers and one or more cells. In other words, the UE 121 may monitor the one or more inter-frequency carriers and one or more cells according to the received configuration.

### Action 303

Based on the monitoring, the UE 121 logs one or more of: one or more MDT measurements relating to the received configuration, and one or more MDT measurement indications, e.g. referred to as indication information. The one or more MDT measurement indications are related to one or more other cells that are stronger than the one more cells in the received configuration.

In some embodiments, the MDT measurement indications is an implicit indication.

In some embodiments, the implicit indication implicitly indicates that at least one of the one or more other cells are stronger than at least one of the one more cells in the received configuration in the received configuration by omitting the at least one of the one or more cells from the measurement report.

In some embodiments, the MDT measurement indication comprises any one or more out of: a flag indicating the presence of the one or more other cells, a Physical Cell Identity, PCI, of the strongest cell in the frequency, the number of the one or more other cells that are stronger than the strongest of the one or more cell.

### Action 304

The UE 121 sends a measurement report to the network node 110. The measurement report comprises one or more of: the one or more logged MDT measurements, and the one or more logged MDT measurement indications. The measurement report enables the network node 110 to any one or more out of: Generate a coverage map, and generate an optimized configuration related to logged MDT measurements. The measurement report may be a logged MDT report.

In some embodiments, the measurement report comprises any one of: an indication for each of the one or more inter-frequency carrier, or an indication of for all of the one or more inter-frequency carriers.

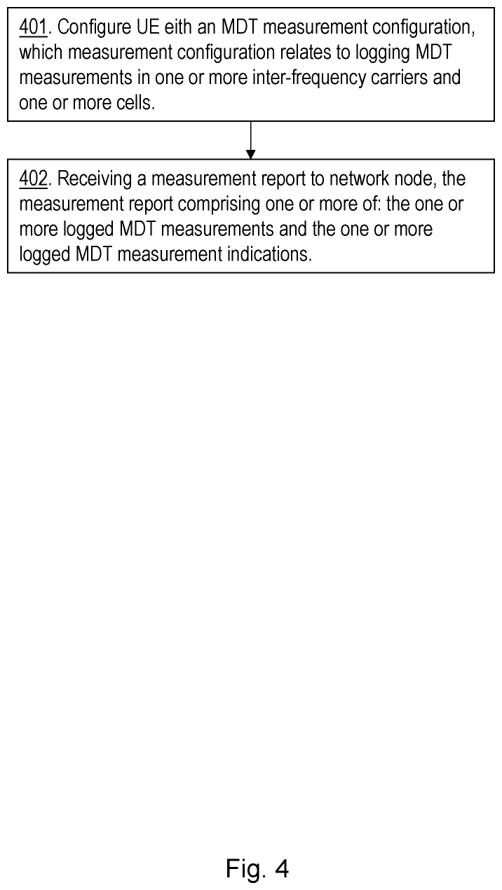

FIG. 4 shows an example method performed by the network node 110, e.g. for assisting the UE 121 in for performing measurement logging related to logged MDT measurements in the wireless communications network 100. The method comprises any one or more out of the actions below, which actions may be taken in any suitable order:

### Action 401

The network node 110 configures the UE 121 with an MDT measurement configuration. The measurement configuration relates to logging MDT measurements in one or more inter-frequency carriers and one or more cells.

The one or more cells may be one or more sets of cells. Each set of cells out of the one or more sets of cells may comprise one or more cells.

Inter-frequency carriers when used herein, may mean carriers of different frequencies. The UE 121 may e.g., log MDT measurements according to each of the one or more inter-frequency carriers that the UE 121 not camped one when operating in an idle mode of operation. For example, the MDT measurement configuration comprises the inter-frequency carries f1, f2, f3 and f4 and the UE 121 is camped on f3. This means that the UE 121 may treat the frequency f3 as a serving frequency, and log e.g., MDT measurements and/or MDT measurement indications according to the received MDT measurement configuration for the frequencies, such as the inter-frequency carriers, f1, f2 and f4.

Each of the one or more inter-frequency carriers may be associated to one or more of the one or cells in the received configuration. In other words, the one or more inter-frequency carriers may be associated to a respective set of cells from the one or more cells. The respective sets of cells may comprise one or more cells, and the respective set of cells may be overlapping or disjoint sets of cells.

In some embodiments, the MDT measurement configuration configures the UE 121 to log one or more MDT measurement indications when the one or more cells in the received configuration is not the strongest cell in the corresponding frequency.

Configuring, when used herein, may e.g., mean sending or in any other way obtaining the configuration to the UE 121. This definition is however not limited to this specific example but holds for any use of the word configuring herein.

### Action 402

The network node 110 receives 402 a measurement report from the UE 121. The measurement report comprises one or more of: One or more logged MDT measurements, and one or more logged MDT measurement indications, e.g. referred to as indication information, related to one or more other cells that are stronger than the one more cells in the configuration. The measurement report enables the network node 110 to any one or more out of: generate a coverage map, and generate an optimized configuration related to logged MDT measurements. The measurement report may be a logged MDT report.

In some embodiments, the MDT measurement indications is an implicit indication.

In some embodiments, the implicit indication implicitly indicates that at least one of the one or more other cells are stronger than at least one of the one more cells in the received configuration in the received configuration by omitting the at least one of the one or more cells from the measurement report.

In some embodiments, the MDT measurement indication comprises any one or more out of: a flag indicating the presence of the one or more other cells, a Physical Cell Identity, PCI, of the strongest cell in the frequency, the number of the one or more other cells that are stronger than the strongest of the one or more cell.

In some embodiments, the measurement report comprises any one of: an indication for each of the one or more inter-frequency carrier, or an indication of for all of the one or more inter-frequency carriers.

The method will now be further explained and exemplified in below embodiments. These below embodiments may be combined with any suitable embodiment as described above.

Examples of embodiments herein provides a method e.g. performed by the UE 121, to log information indicating the strongest cell in a given frequency as part of a logged MDT report. The UE 121 may also be referred to as the wireless terminal 121. According the example, the method may comprise the following actions.

The UE 121 receives a logged MDT configuration, such as e.g., the measurement configuration described in relation to Action 301 and 401 above, from the network, such as the network node 110. The logged MDT configuration may comprise information, such as one or more information elements, related to measurement logging in inter-frequency carriers and cells, such as the one or more inter-frequency carriers and one or more cells, as per current standard. The information, or information elements, may e.g. be InterfreqTargetInfo containing cellList IEs.

This may be related to, or combined with, Actions 301 and 401 as described above.

The UE 121 may transition to RRC_IDLE, camped normally state. This may mean that after receiving the logged MDT configuration, the UE 121 may switch to RRC_IDLE state, find a suitable cell and be in camped normally state in that cell. Furthermore, UE 121 starts monitoring the configured frequencies and cells.

This may be related to, or combined with, Action 302 as described above.

The UE 121 logs measurements and indicator information, such as e.g. the one or more MDT measurements and one or more MDT measurement indications, described in relation to Actions 303 and 402 above, related to the configured frequency and cells received in action A501.

This may be related to, or combined with, Actions 303 and 402 as described above.

In some embodiments, the indicator information, such as e.g. the one or more MDT measurement indications, is logged only when the configured cells, such as e.g., the one or more cells received in the MDT measurement configuration, are not the strongest cells in the corresponding frequency. The cells may be configured in a cellist IE as described above, e.g., by PCIs.

This may be related to, or combined with, Actions 301 and 401 as described above.

In some embodiments, the indicator information, such as e.g. the one or more MDT measurement indications, is logged implicitly by not logging measurements of one or more of the configured cells, such as e.g., the one or more cells received in the MDT measurement configuration, if there is at least one stronger cell in the frequency than those cells whose measurements are omitted.

In an example, the network, such as e.g., the network node 110, may have configured the UE 121 to log measurements related to PCI 1,2,3,4. However, at a point e.g., PCI 5 may have been stronger than PCI 3 and PCI 4, but worse than PCI 1 and PCI 2. Then, the UE 121 may be configured to log measurements related to PCI 1,2 but not PCI 3 and PCI 4. At a later point, e.g., PCI 5 may become stronger than all the configured PCIs, then the UE 121 may omit to log measurements related to PCI 1,2,3,4.

This may be related to, or combined with, Actions 302 and 402 as described above.

In some embodiments, the UE 121 may log indicator information, such as e.g. the one or more MDT measurement indications, where there is at least one cell that is stronger than the cells logged in the report. This may e.g., be a one-bit indicator flag which indicates the presence of a different cell, such as the at least one of the one or more other cells described above, being the strongest cell. This may be related to, or combined with, Actions 303 and 402 as described above.

In some embodiments, the UE 121 may log the PCI of the strongest cell in the frequency. This may be related to, or combined with, Actions 303 and 402 as described above.

In some embodiments, the UE 121 may log the number of stronger cells, such as the number of the one or more other cells that are stronger, than the configured cells, such as e.g., the one or more cells in the received configuration or MDT measurement configuration, in the frequency, such as e.g., the one or more inter-frequency carriers.

The number of stronger cells may be calculated as the number of cells that are stronger than the strongest cell in the configured list of cells in the frequency.

This may be related to, or combined with, Actions 303 and 402 as described above.

An example implementation according to embodiments herein in view of 3GPP TS 38.331 is provided below. In the example below, the UE 121 is referred to as UE.
5.5a.3.2 Initiation
While T330 is running, the UE shall:
1> perform the logging in accordance with the following:
   2> if the reportType is set to periodical in the VarLogMeasConfig:
      3> if the UE is in any cell selection state (as specified in TS 38.304 [20]):
         4> perform the logging at regular time intervals, as defined by the loggingInterval in the VarLogMeasConfig;
      3> if the UE is in camped normally state on an NR cell and if the RPLMN is included in plmn-IdentityList stored in VarLogMeasReport:
         4> if areaConfiguration is not included in VarLogMeasConfig; or
         4> if the serving cell is part of the area indicated by areaConfig in areaConfiguration in VarLogMeasConfig:
         5> perform the logging at regular time intervals, as defined by the loggingInterval in the VarLogMeasConfig;
   2> else if the reportType is set to eventTriggered, and eventType is set to outOfCoverage:
      3> perform the logging at regular time intervals as defined by the loggingInterval in VarLogMeasConfig only when the UE is in any cell selection state;
      3> upon transition from any cell selection state to camped normally state in NR:
         4> if the RPLMN is included in plmn-IdentityList stored in VarLogMeasReport; and
         4> if areaConfiguration is not included in VarLogMeasConfig or if the current camping cell is part of the area indicated by areaConfig of areaConfiguration in VarLogMeasConfig:
         5> perform the logging;
   2> else if the reportType is set to eventTriggered and eventType is set to eventL1:
      3> if the UE is in camped normally state on an NR cell and if the RPLMN is included in plmn-IdentityList stored in VarLogMeasReport:
         4> if areaConfiguration is not included in VarLogMeasConfig; or
         4> if the serving cell is part of the area indicated by areaConfig in areaConfiguration in VarLogMeasConfig;
         5> perform the logging at regular time intervals as defined by the loggingInterval in VarLogMeasConfig only when the conditions indicated by the eventL1 are met;
   2> when performing the logging:
      3> set the relative TimeStamp to indicate the elapsed time since the moment at which the logged measurement configuration was received;
      3> if location information became available during the last logging interval, set the content of the locationInfo as in 5.3.3.7:
      3> if the UE is in any cell selection state (as specified in TS 38.304 [20]):
         4> set anyCellSelectionDetected to indicate the detection of no suitable or no acceptable cell found;
         4> if the reportType is set to eventTriggered in the VarLogMeasConfig; and
         4> if the RPLMN at the time of entering the any cell selection state is included in plmn-IdentityList stored in VarLogMeasReport; and
         4> if areaConfiguration is not included in VarLogMeasConfig or if the last suitable cell that the UE was camping on is part of the area indicated by areaConfig of areaConfiguration in VarLogMeasConfig:
         5> set the servCellldentity to indicate global cell identity of the last suitable cell that the UE was camping on;
         5> set the measResultServingCell to include the quantities of the last suitable cell the UE was camping on;
         4> else if the reportType is set to periodical in the VarLogMeasConfig:
         5> set the servCellldentity to indicate global cell identity of the last logged cell that the UE was camping on;
         5> set the measResultServingCell to include the quantities of the last logged cell the UE was camping on;
      3> else:
         4> set the servCellldentity to indicate global cell identity of the cell the UE is camping on;
         4> set the measResultServingCell to include the quantities of the cell the UE is camping on;
      3> if available, set the measResultNeighCells, in order of decreasing ranking-criterion as used for cell re-selection, to include measurements of neighbouring cell that became available during the last logging interval and according to the following:
         4> include measurement results for at most 6 neighbouring cells on the NR serving frequency and for at most 3 cells per NR neighbouring frequency and for the NR neighbouring frequencies in accordance with the following:
         5> if interFreqTargetInfo is included in VarLogMeasConfig:
         6> include measurement results for NR each of the neighbouring frequencies that are included in both interFreqTargetInfo and SIB4 in accordance with the following;
         7> if cellList is included in interFreqTargetInfo associated to the frequency in the interFreqTargetInfo:
         8> include measurement results for cells in the cellList only if they are the strongest cells in the frequency.
         7> else:
         8> include measurement results for cells on that frequency.
         5> else:
         6> include measurement results for NR neighbouring frequencies that are included in SIB4;
         4> include measurement results for at most 3 neighbours per inter-RAT frequency that is included in SIB5;
         4> for each neighbour cell included, include the optional fields that are available;
NOTE: The UE, such as e.g., the UE 121, includes, such as comprises, the latest results of the available measurements as used for cell reselection evaluation in RRC_IDLE or RRC_INACTIVE, which are performed in accordance with the performance requirements as specified in TS 38.133.
   2> when the memory reserved for the logged measurement information becomes full, stop

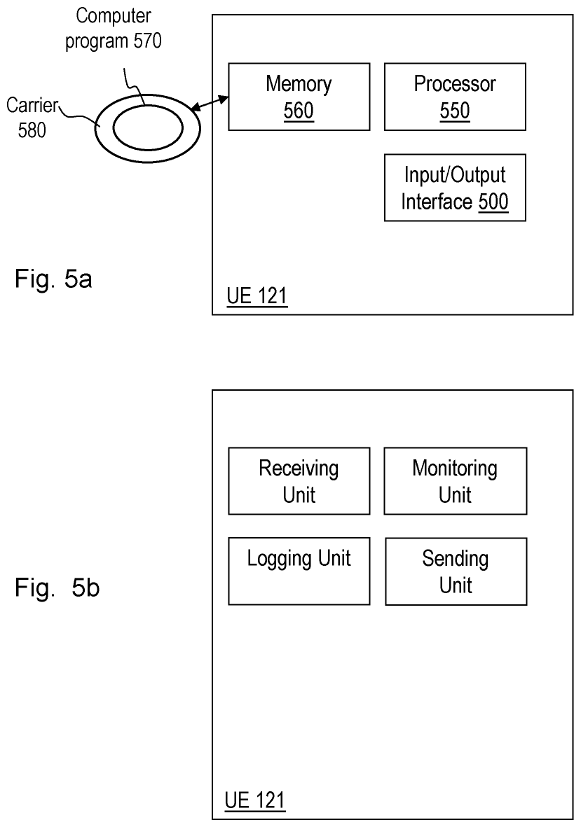

FIGS. 5a and 5b shows an example of arrangement in the UE 121.

The UE 121 may comprise an input and output interface 500 configured to communicate with each other. The input and output interface 500 may comprise a receiver, e.g. wired and/or wireless, (not shown) and a transmitter, e.g. wired and/or wireless, (not shown).

The UE 121 may comprise any one or more out of: A receiving unit, a monitoring unit, a logging unit, a sending unit, to perform the method actions as described herein.

The embodiments herein may be implemented through a respective processor or one or more processors, such as at least one processor 550 of a processing circuitry in the UE 121 depicted in FIG. 5a, together with computer program code for performing the functions and actions of the embodiments herein. The program code mentioned above may also be provided as a computer program product, for instance in the form of a data carrier carrying computer program code for performing the embodiments herein when being loaded into the UE 121. One such carrier may be in the form of a CD ROM disc. It is however feasible with other data carriers such as a memory stick. The computer program code may furthermore be provided as pure program code on a server and downloaded to the UE 121.

The UE 121 may further comprise respective a memory 560 comprising one or more memory units. The memory 560 comprises instructions executable by the processor in the UE 121.

The memory 560 is arranged to be used to store configurations, measurements, indications, data, and applications to perform the methods herein when being executed in the UE 121.

In some embodiments, a computer program 570 comprises instructions, which when executed by the at least one processor 550, cause the at least one processor 550 of the UE 121 to perform the actions above.

In some embodiments, a respective carrier 580 comprises the respective computer program 570, wherein the carrier 580 is one of an electronic signal, an optical signal, an electromagnetic signal, a magnetic signal, an electric signal, a radio signal, a microwave signal, or a computer-readable storage medium.

Those skilled in the art will also appreciate that the functional modules in the UE 121, described below may refer to a combination of analog and digital circuits, and/or one or more processors configured with software and/or firmware, e.g. stored in the UE 121, that when executed by the respective one or more processors such as the at least one processor 550 described above cause the respective at least one processor 550 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

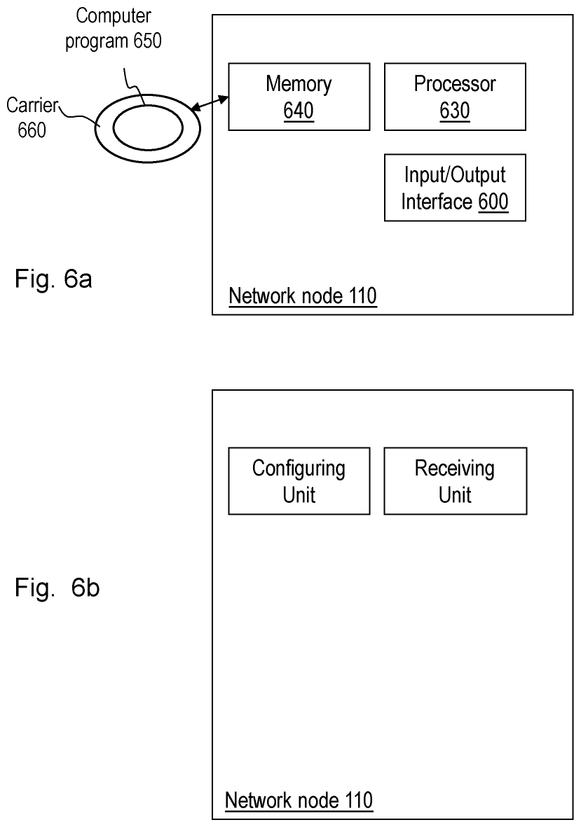

FIGS. 6a and 6b shows an example of arrangement in the network node 110.

The network node 110 may comprise an input and output interface 600 configured to communicate with each other. The input and output interface 600 may comprise a receiver, e.g. wired and/or wireless, (not shown) and a transmitter, e.g. wired and/or wireless, (not shown).

The network node 110 may comprise any one or more out of: A configuring unt, a receiving unit, to perform the method actions as described herein.

The embodiments herein may be implemented through a respective processor or one or more processors, such as at least one processor 630 of a processing circuitry in the UE 121 depicted in FIG. 5a, together with computer program code for performing the functions and actions of the embodiments herein. The program code mentioned above may also be provided as a computer program product, for instance in the form of a data carrier carrying computer program code for performing the embodiments herein when being loaded into the UE 121. One such carrier may be in the form of a CD ROM disc. It is however feasible with other data carriers such as a memory stick. The computer program code may furthermore be provided as pure program code on a server and downloaded to the UE 121.

The UE 121 may further comprise respective a memory 640 comprising one or more memory units. The memory 640 comprises instructions executable by the processor in the network node 110.

The memory 640 is arranged to be used to store configurations, measurements, indications, data, and applications to perform the methods herein when being executed in the network node 110.

In some embodiments, a computer program 650 comprises instructions, which when executed by the at least one processor 630, cause the at least one processor 630 of the network node 110 to perform the actions above.

In some embodiments, a respective carrier 660 comprises the respective computer program 650, wherein the carrier 660 is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 110, described below may refer to a combination of analog and digital circuits, and/or one or more processors configured with software and/or firmware, e.g. stored in the network node 110, that when executed by the respective one or more processors such as the at least one processor 850 described above cause the respective at least one processor 850 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### EMBODIMENTS

Below, some example embodiments 1-28 are shortly described. See e.g. FIGS. 2, 3, 4, 5a, 5b, 6a, and 6b.
Embodiment 1. A method performed by a User Equipment, UE, 121 e.g. for performing measurement logging related to logged Minimization of Drive Tests, MDT, measurements in a wireless communications network 100, the method comprising any one or more out of:
receiving 301 an MDT measurement configuration from a network node 110, which measurement configuration relates to logging MDT measurements in one or more inter-frequency carriers and one or more cells,
when operating in an idle mode of operation and in a camped normally state, monitoring 302 the configured one or more inter-frequency carriers and one or more cells,
based on the monitoring 302, logging 303 one or more of:
   one or more MDT measurements relating to the received configuration, and
   one or more MDT measurement indications, e.g. referred to as indication information, related to one or more other cells that are stronger than the one more cells in the received configuration, and
sending 304 a measurement report to the network node 110, the measurement report comprising one or more of:
   the one or more logged MDT measurements, and
   the one or more logged MDT measurement indications,
which measurement report enables the network node 110 to any one or more out of:
   generating a coverage map, and
   generating an optimized configuration related to logged MDT measurements.
Embodiment 2. The method according to embodiment 1, wherein the MDT measurement configuration configures the UE 121 to log the one or more MDT measurement indications when the one or more cells in the received configuration is not the strongest cell in the corresponding frequency.
Embodiment 3. The method according to any of embodiments 1-2, wherein the MDT measurement indication is an implicit indication.
Embodiment 4. The method according to embodiment 3, wherein the implicit indication implicitly indicates that at least one of the one or more other cells are stronger than at least one of the one more cells in the received configuration by omitting the at least one of the one or more cells from the measurement report.
Embodiment 5. The method according to any of embodiments 1-4, wherein the MDT measurement indication comprises any one or more out of:
   a flag indicating the presence of the one or more other cells,
   a Physical Cell Identity, PCI, of the strongest cell in the frequency,
   the number of the one or more other cells that are stronger than the strongest of the one or more cell.
Embodiment 6. The method according to any of embodiments 1-5, wherein the measurement report comprises any one of:
   an indication for each of the one or more inter-frequency carrier, or
   an indication of for all of the one or more inter-frequency carriers.
Embodiment 7. A computer program 570 comprising instructions, which when executed by a processor 550, causes the processor 550 to perform actions according to any of the embodiments 1-6.
Embodiment 8. A carrier 580 comprising the computer program 570 of embodiment 7, wherein the carrier 580 is one of an electronic signal, an optical signal, an electromagnetic signal, a magnetic signal, an electric signal, a radio signal, a microwave signal, or a computer-readable storage medium.
Embodiment 9. A method performed by a network node 110 e.g. for assisting a User Equipment, UE, 121 in performing measurement logging related to logged Minimization of Drive Tests, MDT, measurements in a wireless communications network 100, the method comprising any one or more out of:
configuring 401 the UE 121 with an MDT measurement configuration, which measurement configuration relates to logging MDT measurements in one or more inter-frequency carriers and one or more cells,
receiving 402 a measurement report from the UE 121, the measurement report comprising one or more of:
   one or more logged MDT measurements, and
   one or more logged MDT measurement indications, e.g. referred to as indication information, related to one or more other cells that are stronger than the one more cells in the configuration,
which measurement report enables the network node 110 to any one or more out of:
   generating a coverage map, and
   generating an optimized configuration related to logged MDT measurements.
Embodiment 10. The method according to embodiment 9, wherein the MDT measurement configuration configures the UE 121 to log the one or more MDT measurement indications when the one or more cells in the received configuration is not the strongest cell in the corresponding frequency.
Embodiment 11. The method according to any of embodiments 9-10, wherein the MDT measurement indication is an implicit indication, which implicit indication implicitly indicates that at least
Embodiment 12. The method according to embodiment 11, wherein the implicit indication implicitly indicates that at least one of the one or more other cells are stronger than at least one of the one more cells in the received configuration in the received configuration by omitting the at least one of the one or more cells from the measurement report.
Embodiment 13. The method according to any of embodiments 9-12, wherein the MDT measurement indication comprises any one or more out of:
   a flag indicating the presence of the one or more other cells,
   a Physical Cell Identity, PCI, of the strongest cell in the frequency,
   the number of the one or more other cells that are stronger than the strongest of the one or more cell.
Embodiment 14. The method according to any of embodiments 9-13, wherein the measurement report comprises any one of:
   an indication for each of the one or more inter-frequency carrier, or
   an indication of for all of the one or more inter-frequency carriers.
Embodiment 15. A computer program 650 comprising instructions, which when executed by a processor 630, causes the processor 630 to perform actions according to any of the embodiments 9-14.
Embodiment 16. A carrier 660 comprising the computer program 650 of embodiment 15, wherein the carrier 660 is one of an electronic signal, an optical signal, an electromagnetic signal, a magnetic signal, an electric signal, a radio signal, a microwave signal, or a computer-readable storage medium.
Embodiment 17. A User Equipment, UE, 121 e.g. configured to perform measurement logging related to logged Minimization of Drive Tests, MDT, measurements in a wireless communications network 100, the UE 121 further being configured to:
receive, e.g. by means of a receiving unit in the UE 121, an MDT measurement configuration from a network node 110, which measurement configuration is adapted to be related to logging MDT measurements in one or more inter-frequency carriers and one or more cells,
when operating in an idle mode of operation and in a camped normally state, monitor, e.g. by means of a monitoring unit in the UE 121, the configured one or more inter-frequency carriers and one or more cells,
based on the monitoring, log, e.g. by means of a logging unit in the UE 121, one or more of:
   one or more MDT measurements adapted to be related to the received configuration, and
   one or more MDT measurement indications, e.g. referred to as indication information, adapted to be related to one or more other cells that are stronger than the one more cells in the received configuration, and
send, e.g. by means of a sending unit in the UE 121, a measurement report to the network node 110, the measurement report adapted to comprise one or more of:
   the one or more logged MDT measurements, and
   the one or more logged MDT measurement indications,
which measurement report is adapted to enable the network node 110 to any one or more out of:
   generate a coverage map, and
   generate an optimized configuration adapted to be related to logged MDT measurements.
Embodiment 18. The UE 121 according to embodiment 17, wherein the MDT measurement configuration is adapted to configure the UE 121 to log the one or more MDT measurement indications when the one or more cells in the received configuration is not the strongest cell in the corresponding frequency.
Embodiment 19. The UE 121 according to any of embodiments 17-18, wherein the MDT measurement indication is adapted to be an implicit indication.
Embodiment 20. The UE 121 according to embodiment 19, wherein the implicit indication is adapted to implicitly indicates that at least one of the one or more other cells are stronger than at least one of the one more cells in the received configuration by omitting the at least one of the one or more cells from the measurement report.
Embodiment 21. The UE 121 according to any of embodiments 17-20, wherein the MDT measurement indication is adapted to comprise any one or more out of:
   a flag adapted to indicate the presence of the one or more other cells,
   a Physical Cell Identity, PCI, of the strongest cell in the frequency,
   the number of the one or more other cells that are stronger than the strongest of the one or more cell.
Embodiment 22. The UE 121 according to any of embodiments 17-21, wherein the measurement report is adapted to comprise any one out of:
   an indication for each of the one or more inter-frequency carrier, or
   an indication of for all of the one or more inter-frequency carriers.
Embodiment 23. A network node 110 e.g. configured to assist a User Equipment, UE, 121 in performing measurement logging related to logged Minimization of Drive Tests, MDT, measurements in a wireless communications network 100, the network node 110 further being configured to:
configure, e.g. by means of a configuring unit in the network node 110, the UE 121 with an MDT measurement configuration, which measurement configuration is adapted to be related to logging MDT measurements in one or more inter-frequency carriers and one or more cells,
receive, e.g. by means of a receiving unit in the network node 110, a measurement report from the UE 121, the measurement report adapted to comprise one or more of:
   one or more logged MDT measurements, and
   one or more logged MDT measurement indications, e.g. referred to as indication information, adapted to be related to one or more other cells that are stronger than the one more cells in the configuration,
which measurement report is adapted to enable the network node 110 to any one or more out of:
   generate a coverage map, and
   generate an optimized configuration related to logged MDT measurements.
Embodiment 24. The network node 110 according to embodiment 23, wherein the MDT measurement configuration is adapted to configure the UE 121 to log the one or more MDT measurement indications when the one or more cells in the received configuration is not the strongest cell in the corresponding frequency.
Embodiment 25. The network node 110 according to any of embodiments 23-24, wherein the MDT measurement indication is adapted to be an implicit indication.
Embodiment 26. The network node 110 according to embodiment 25, wherein the implicit indication is adapted to implicitly indicate that at least one of the one or more other cells are stronger than at least one of the one more cells in the configuration by omitting the at least one of the one or more cells from the measurement report.
Embodiment 27. The network node 110 according to any of embodiments 23-26, wherein the MDT measurement indication is adapted to comprise any one or more out of:
   a flag adapted to indicate the presence of the one or more other cells,
   a Physical Cell Identity, PCI, of the strongest cell in the frequency,
   the number of the one or more other cells that are stronger than the strongest of the one or more cell.
Embodiment 28. The method according to any of embodiments 9-13, wherein the measurement report is adapted to comprise any one of:
   an indication for each of the one or more inter-frequency carrier, or
   an indication of for all of the one or more inter-frequency carriers.

### ABBREVIATIONS

Below follows some abbreviations as used herein and their corresponding explanations.

| Abbreviation | Explanation |
|---|---|
| RAT | Radio Access Technology |
| MDT | Minimization of Drive Test |
| UE | User Equipment |
| RRC | Radio Resource Control |

### FURTHER EXTENSIONS AND VARIATIONS

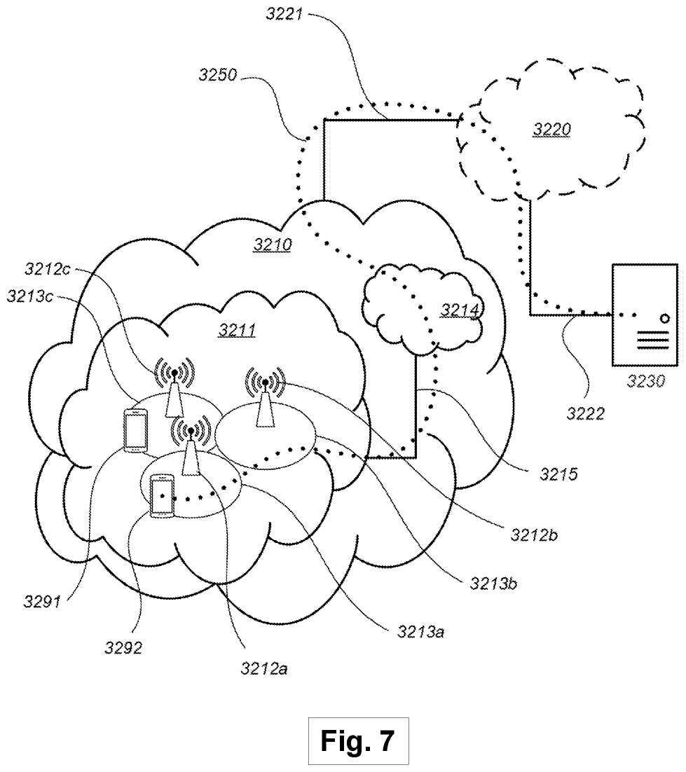

With reference to FIG. 7, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 121 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

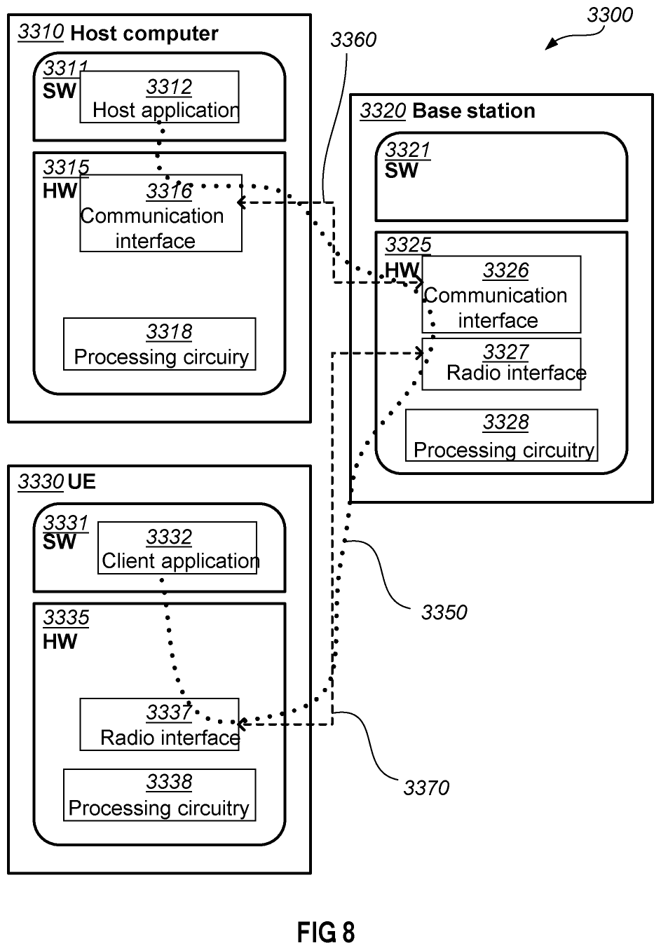

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

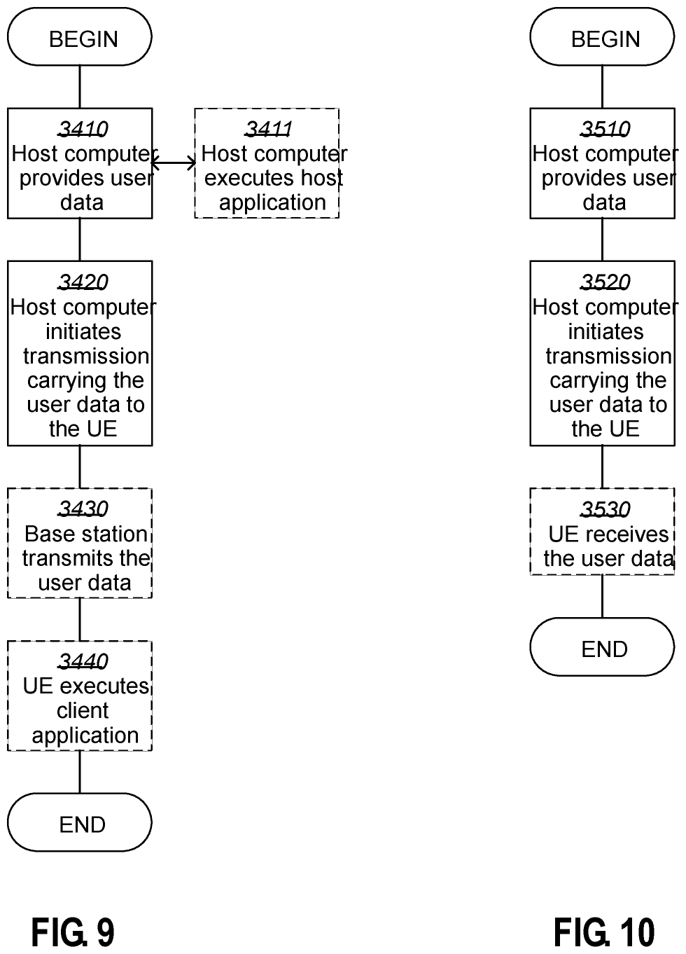

FIG. 9 is a flowchart illustrating a method implemented in a communication system, in accordance with one embodiment. The communication system includes a host computer, a base station such as the network node 112, and a UE such as the UE 120, which may be those described with reference to FIG. 7 and FIG. 8. For simplicity of the present disclosure, only drawing references to FIG. 9 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 10 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

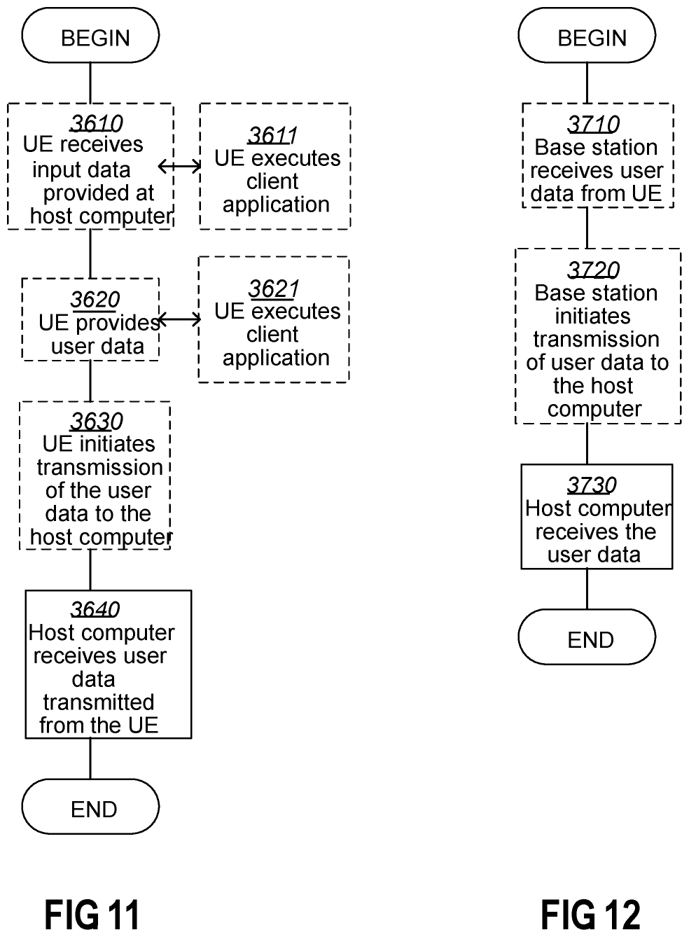

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 11 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 12 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1. A method performed by a User Equipment (UE) for performing measurement logging related to logged Minimization of Drive Tests (MDT) measurements in a wireless communications network, the method comprising:
receiving an MDT measurement configuration from a network node, which MDT measurement configuration relates to logging MDT measurements in one or more inter-frequency carriers and one or more cells, when operating in an idle mode of operation and in a camped normally state;
monitoring the one or more inter-frequency carriers and one or more cells;
logging one or more of:
one or more MDT measurements relating to the received MDT measurement configuration, and
one or more MDT measurement indications related to one or more other cells that are stronger than the one or more cells in the received MDT measurement configuration; and
sending a measurement report to the network node, the measurement report comprising one or more of:
the one or more logged MDT measurements, and
the one or more logged MDT measurement indications,
which measurement report enables the network node to any one or more of:
generating a coverage map, and
generating an optimized configuration related to logged MDT measurements.

2. The method according to claim 1, wherein the MDT measurement configuration configures the UE to log the one or more MDT measurement indications when the one or more cells in the received MDT measurement configuration is not a strongest cell in a corresponding frequency.

3. The method according to claim 1, wherein at least one of the one or more MDT measurement indications is an implicit indication.

4. The method according to claim 3, wherein the implicit indication implicitly indicates that at least one of the one or more other cells are stronger than at least one of the one or more cells in the received MDT measurement configuration by omitting at least one of the one or more cells from the measurement report.

5. The method according to claim 1, wherein at least one of the MDT measurement indication comprises any one or more of:
a flag indicating a presence of the one or more other cells,
a Physical Cell Identity (PCI) of a strongest cell in a frequency, and
a number of the one or more other cells that are stronger than a strongest cell of the one or more cells.

6. The method according to claim 1, wherein the measurement report comprises:
an indication for each of the one or more inter-frequency carriers, or
an indication for all of the one or more inter-frequency carriers.

7-8. (canceled)

9. A method performed by a network node for assisting a User Equipment (UE) in performing measurement logging related to logged Minimization of Drive Tests (MDT) measurements in a wireless communications network, the method comprising:
configuring the UE with an MDT measurement configuration, which MDT measurement configuration relates to logging MDT measurements in one or more inter-frequency carriers and one or more cells; and
receiving a measurement report from the UE, the measurement report comprising one or more of:
one or more logged MDT measurements, and
one or more logged MDT measurement indications related to one or more other cells that are stronger than the one or more cells in the MDT measurement configuration,
which measurement report enables the network node to any one or more of:
generating a coverage map, and
generating an optimized configuration related to logged MDT measurements.

10. The method according to claim 9, wherein the MDT measurement configuration configures the UE to log the one or more MDT measurement indications when the one or more cells in the received MDT measurement configuration is not a strongest cell in a corresponding frequency.

11. The method according to claim 9, wherein at least one of the one or more MDT measurement indications is an implicit indication.

12. The method according to claim 11, wherein the implicit indication implicitly indicates that at least one of the one or more other cells are stronger than at least one of the one or more cells in the received MDT measurement configuration by omitting at least one of the one or more cells from the measurement report.

13. The method according to claim 9, wherein the MDT measurement indication comprises any one or more-out of:
a flag indicating a presence of the one or more other cells,
a Physical Cell Identity (PCI) of a strongest cell in a frequency, and
a number of the one or more other cells that are stronger than a strongest cell of the one or more cells.

14. The method according to claim 9, wherein the measurement report comprises:
an indication for each of the one or more inter-frequency carriers, or
an indication for all of the one or more inter-frequency carriers.

15-16. (canceled)

17. A User Equipment (UE) configured to perform measurement logging related to logged Minimization of Drive Tests (MDT) measurements in a wireless communications network, the UE comprising:
a processor; and
a memory comprising instructions, in which the instructions when executed by the processor, cause the UE to:
receive an MDT measurement configuration from a network node, which MDT measurement configuration is related to logging MDT measurements in one or more inter-frequency carriers and one or more cells, when operating in an idle mode of operation and in a camped normally state;
monitor the one or more inter-frequency carriers and one or more cells;
log one or more of:
one or more MDT measurements related to the received MDT measurement configuration, and
one or more MDT measurement indications related to one or more other cells that are stronger than the one or more cells in the received MDT measurement configuration; and
send a measurement report to the network node, the measurement report comprises one or more of:
the one or more logged MDT measurements, and
the one or more logged MDT measurement indications,
which measurement report is to enable the network node to any one or more of:
generate a coverage map, and
generate an optimized configuration related to logged MDT measurements.

18-22. (canceled)

23. A network node configured to assist a User Equipment (UE) in performing measurement logging related to logged Minimization of Drive Tests (MDT) measurements in a wireless communications network, the network node comprising:
a processor; and
a memory comprising instructions, in which the instructions when executed by the processor, cause the network node to:
configure the UE with an MDT measurement configuration, which MDT measurement configuration is related to logging MDT measurements in one or more inter-frequency carriers and one or more cells and
receive a measurement report from the UE, the measurement report comprises one or more of:
one or more logged MDT measurements, and
one or more logged MDT measurement indications related to one or more other cells that are stronger than the one or more cells in the MDT measurement configuration,
which measurement report is to enable the network node to any one or more of:
generate a coverage map, and
generate an optimized configuration related to logged MDT measurements.

24-28. (canceled)

29. The UE according to claim 17, wherein the MDT measurement configuration configures the UE to log the one or more MDT measurement indications when the one or more cells in the received MDT measurement configuration is not a strongest cell in a corresponding frequency.

30. The UE according to claim 17, wherein at least one of the one or more MDT measurement indications is an implicit indication.

31. The UE according to claim 30, wherein the implicit indication implicitly indicates that at least one of the one or more other cells are stronger than at least one of the one or more cells in the received MDT measurement configuration by omitting at least one of the one or more cells from the measurement report.

32. The network node according to claim 23, wherein the MDT measurement configuration configures the UE to log the one or more MDT measurement indications when the one or more cells in the received MDT measurement configuration is not a strongest cell in a corresponding frequency.

33. The network node according to claim 23, wherein at least one of the one or more MDT measurement indications is an implicit indication.

34. The network node according to claim 33, wherein the implicit indication implicitly indicates that at least one of the one or more other cells are stronger than at least one of the one or more cells in the received MDT measurement configuration by omitting at least one of the one or more cells from the measurement report.
